(19) United States
(12) Patent Application Publication
(10) Pub. No.: US 2010/0072161 A1
(43) Pub. Date: Mar. 25, 2010

(54) Device and Method for Feeding Breast Milk and Similar Nutritionals to Infants

(76) Inventor: Gregory R. Viggiano, Alexandria, VA (US)

Correspondence Address: SHOEMAKER AND MATTARE, LTD, 10 POST OFFICE ROAD - SUITE 100, SILVER SPRING, MD, 20910, US

(21) Appl. No.: 12/423,388

(22) Filed: Apr. 14, 2009

Related U.S. Application Data
(60) Provisional application No. 61/098,381, filed on Sep. 19, 2008.

(51) Int. Cl. A61J 9/00; B65D 30/02; B65D 30/20

(52) U.S. Cl. 215/11.3; 383/1; 383/120

(57) ABSTRACT

A single-use, disposable device for feeding breast milk and similar nutritionals to infants and babies includes a pre-sterilized, semi rigid, flexible storage bag having a sealable end and a barbed fitment plugged with a removable ring pin that allows a temporary seal until the bag is ready to be used for infant feeding. The ring is pulled to remove the pin from the barbed fitment, allowing a feeding nipple device to be attached so the infant can draw breast milk directly from the feeding nipple device connected to the semi rigid, flexible storage bag containing the breast milk.

This application claims benefit of provisional patent application 61/098381, filed Sep. 19, 2008.

### BACKGROUND OF THE INVENTION

The present invention relates generally to an improved method and device for the feeding of breast milk and similar nutritionals to infants and babies. “Nutritional” is a word used in some circles as a generic term describing nutritious liquid foods.

It is common for mothers to express breast milk into storage containers using a pump mechanism. Typically, the storage containers can be bottles attached directly to the pump or single-use disposable bags for freezer storage.

Single-use disposable bags for freezer storage are very popular and widely used, but present several problems with respect to usability, handling, and convenience. Presently, single-use disposable bags for freezer storage are difficult to handle; this creates usability issues and an inconvenient user experience.

This invention relates to simplifying the user experience by improving the method and procedure for product usability while saving time, reducing residual breast milk waste, and eliminate potential spilling.

Commonly available single-use disposable bags for freezer storage typically require a more complex method consisting of several steps before being able to feed the baby. For example, once the mother is finished pumping the breast milk into the single-use disposable bag, it is usually sealed, labeled, and placed in the freezer for storage and later use. When the breast milk is ready to be used, the single-use disposable bag is removed from the freezer and brought to the desired feeding temperature. The breast milk is then usually transferred to a baby bottle to feed the infant. In addition to the inconvenience and extra time required, the transfer from the bag to the bottle increases the potential for spillage and creates residual breast milk waste in the empty bag to be discarded—and additional waste with any remaining breast milk that is left in the baby bottle that was used for the feeding.

Other procedural problems present themselves with respect to handling, portability, and general usability.

Among the objects of my invention is to provide a more efficient and easier method for mothers that currently use single-use disposable bags for breast milk storage. This improvement will be more convenient, save time, be easier to handle, reduce breast milk residual waste, and eliminate potential spilling.

### SUMMARY OF THE INVENTION

It is common knowledge that it is preferred for mothers to breast feed their babies. Anything that can simplify and make breast feeding easier and less difficult would be a welcome improvement over existing products and procedures.

This invention is directed towards providing a more efficient and easier alternative method for mothers that currently use single-use disposable bags for breast milk storage. This improvement is more convenient, saves time, is easier to handle, reduces breast milk residual waste, and eliminates potential spilling.

The present invention aims to simplify current baby feeding methods with an improved product design, providing a semi rigid, flexible storage bag designed to contain breast milk (or similar infant nutritionals). The pre-sterilized, semi rigid, flexible storage bag has a sealable opening to which the bag is attached to the breast pump mechanism. Once the bag is filled with breast milk it can be sealed using a zip lock, adhesive, or similar type closure. The bag can then be freezer stored as usual. When the bag is ready to be used and brought to the desired feeding temperature, instead of transferring the breast milk into yet another container for feeding the infant, the bag itself is used as the feeding container. On the opposite end of the sealable closure, a barbed fitment is molded into the structure of the bag. The barbed fitment is plugged with a ring pin that allows a temporary seal until the bag is ready to be used for infant feeding. To break the seal, the ring is simply pulled away to remove the pin from the barbed fitment thus opening the passageway. With the ring pin removed, a feeding nipple device can be then attached to the barbed fitment allowing the infant to draw breast milk from the feeding nipple device connected to the semi rigid, flexible storage bag containing the breast milk.

This invention is embodied to include low-cost plastic injection molding and manufacturing processes; whereas this mechanism can be practiced as a biodegradable, non-reusable device.

### BRIEF DESCRIPTION OF THE DRAWINGS

FIG. 1 is a side view of the preferred embodiment of the invention showing the disposable nursing bag with the ring pin connected to the barbed fitment.

FIG. 2 is a side view of the embodiment in FIG. 1 with a feeding nipple device attached to the barbed fitment of the disposable nursing bag.

FIG. 3 is a cross-sectional view of the barbed fitment in FIG. 1 with ring pin connected to the barbed fitment.

FIG. 4 is a cross-sectional view of the barbed fitment in FIG. 1 with ring pin removed and the feeding nipple device attached to the barbed fitment.

FIG. 5 is a magnified cross section of the ring pin joint connected to the barbed fitment in FIG. 3.

### DETAILED DESCRIPTION OF THE PREFERRED EMBODIMENT(S)

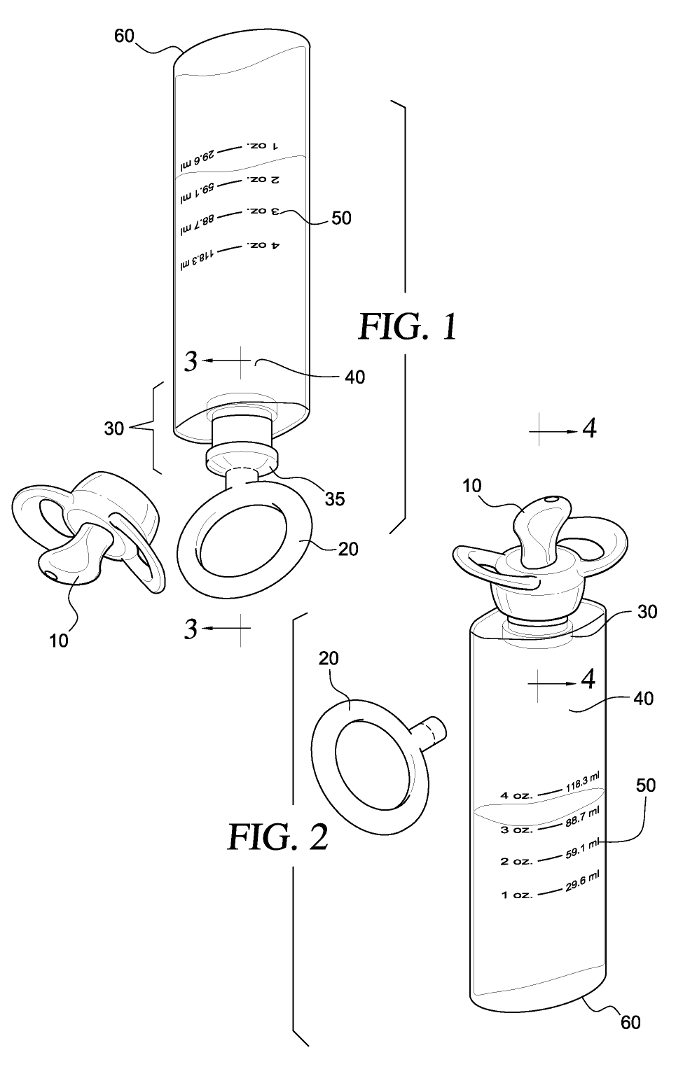

The invention is best described by referring to FIG. 1 as the preferred embodiment. FIG. 1 shows a flexible bag structure 40 with a sealable opening 60 on one end that is used to fill the bag with breast milk or similar infant nutritionals. On each side of the bag 40, are numeric volume scales 50; on one side is a metric scale, the other side is in standard units. The bag 40 is fitted with a fitment 30 that is plugged with a ring pin 20.

FIG. 2 shows the ring pin 20 removed from the fitment 30 to allow a feeding nipple device 10 to be attached to the barb 35 of the fitment 30 and bag 40.

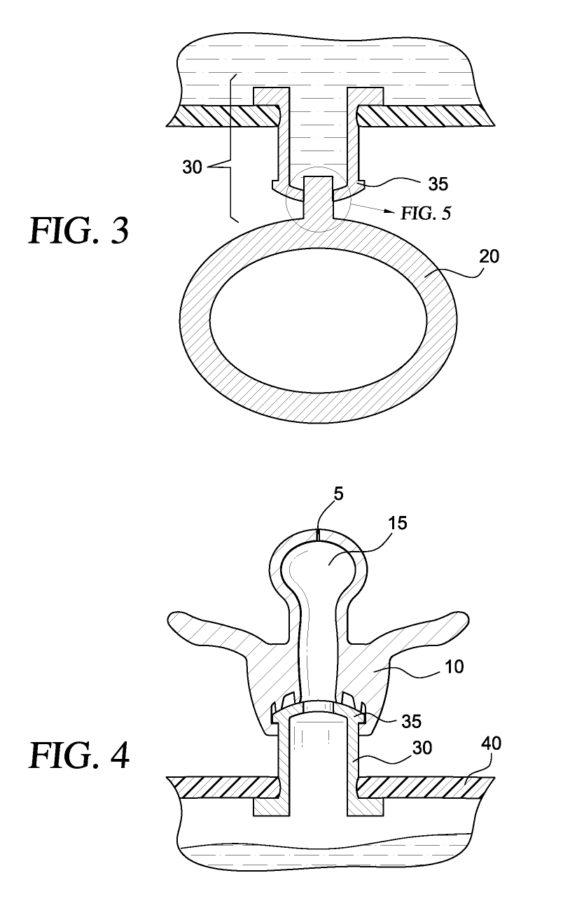

FIG. 3 shows a cross sectional view of the ring pin 20 attached to the fitment 30 with a barb 35 that keeps the feeding nipple device (not shown in FIG. 3) from becoming unattached.

FIG. 4 shows a cross sectional view of the ring pin (not shown) removed and the feeding nipple device 10 attached to the barb 35 of the fitment 30 and bag 40. The feeding nipple device 10 and fitment passage way 15 illustrates how the breast milk would flow from the bag 40 through the fitment 30 to the nipple device 10 and out the feeding nipple device tip opening 5.

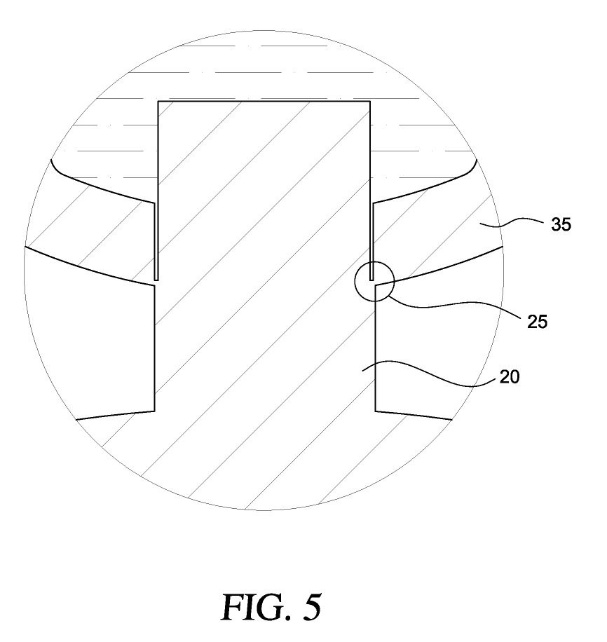

FIG. 5 shows a magnified cross sectional view of how the ring pin 20 is joined to the barb 35 of the fitment 30 via a ring pin molded joint 25.

While the above mentioned description describes the preferred embodiment, other arrangements may be practiced. It is also understood that the invention is not limited to the embodiments discussed here, but are limited to the scope of the claims set forth within this application.

I claim:

1. An infant nursing bag for feeding breast milk and similar nutritionals to infants and babies, said bag comprising a semi rigid, flexible structure suitable for freezing and storing breast milk or other liquids.

2. The invention of claim 1, wherein the infant nursing bag has a volume scale in metric units.

3. The invention of claim 1, wherein the infant nursing bag has a volume scale in standard units.

4. The invention of claim 1, wherein the infant nursing bag has an expandable gusset.

5. The invention of claim 1, wherein the infant nursing bag is biodegradable.

6. The invention of claim 1, wherein the infant nursing bag is designed for a single use.

7. The invention of claim 1, wherein the infant nursing bag is disposable.

8. The invention of claim 1, wherein the infant nursing bag is pre-sterilized.

9. The invention of claim 1, wherein the infant nursing bag has a fitment for attaching a feeding nipple device on one end of the bag.

10. The invention of claim 9, wherein the fitment is barbed.

11. The invention of claim 9, wherein the fitment is plugged with a ringed pin.

12. The invention of claim 1, wherein the infant nursing bag has a sealable closure on one end thereof.

13. The invention of claim 12, wherein the closure is a zip-lock device.

14. The invention of claim 12, wherein the closure is an adhesive.

15. A method of feeding breast milk and similar nutritionals to an infant, said method comprising steps of:
pumping breast milk into a single-use disposable bag having a sealable opening,
sealing the opening and labeling the bag,
storing the bag in a refrigerator, freezer or cooler,
removing the bag from the refrigerator, freezer or cooler and reheating it to a desired feeding temperature,
unsealing the opening and installing a nipple therein,
feeding the infant, and then
discarding the bag.
